(19) United States
(12) Patent Application Publication
(10) Pub. No.: US 2026/0342377 A1
(43) Pub. Date: Oct. 29, 2026

(54) RADIO FREQUENCY CIRCUIT

(71) Applicant: Murata Manufacturing Co., Ltd., Nagaokakyo-shi (JP)

(72) Inventors: Masayuki MAEZAWA, Nagaokakyo-shi (JP); Minoru IWANAGA, Nagaokakyo-shi (JP); Shun HARADA, Nagaokakyo-shi (JP); Yuudai TANOUE, Nagaokakyo-shi (JP); Takuma KUROYANAGI, Nagaokakyo-shi (JP); Koshi ODA, Nagaokakyo-shi (JP)

(73) Assignee: Murata Manufacturing Co., Ltd., Nagaokakyo-shi (JP)

(21) Appl. No.: 19/557,187

(22) Filed: Mar. 5, 2026

(30) Foreign Application Priority Data
Apr. 25, 2025 (JP) 2025-073237

(51) Int. Cl. H04B 1/44

(52) U.S. Cl. CPC H04B 1/44

(57) ABSTRACT

A radio frequency circuit includes a first filter having a pass band for a first band A, a second filter having a pass band for a second band, and a switch circuit. The switch circuit includes a common terminal 410 connected to an antenna connection terminal, a first selection terminal connected to the first filter, and a second selection terminal connected to the second filter. A first matching network is connected between the first selection terminal and the first filter. A second matching network is connected between the second selection terminal and the second filter. In a first mode for receiving the first band and no signal in the second band, the first switch circuit connects the common terminal to both the first selection terminal and the second selection terminal.

### CROSS-REFERENCE TO RELATED APPLICATION

This application claims priority to Japanese Patent Application No. 2025-073237, filed on Apr. 25, 2025, the entire contents of which are incorporated herein by reference.

### BACKGROUND

### 1. Field

The present disclosure relates to a radio frequency circuit.

### 2. Description of the Related Art

International Publication No. 2019/049545 discloses a radio frequency circuit including a switch circuit and an impedance circuit (matching network) that are connected between two signal paths and a ground to reduce resistance losses due to switching.

### SUMMARY

A radio frequency circuit according to an aspect includes: a first filter having a pass band including a reception band of a first band; a second filter having a pass band including a reception band of a second band; a switch circuit including a common terminal connected to an antenna connection terminal, a first selection terminal connected to the first filter, and a second selection terminal connected to the second filter; a first matching network connected between the first selection terminal and the first filter; and a second matching network connected between the second selection terminal and the second filter. In a first mode in which a signal in the first band is received and no signal in the second band is received, the switch circuit is configured to connect the common terminal to the first selection terminal and the second selection terminal.

### BRIEF DESCRIPTION OF THE DRAWINGS

FIG. 1 is a configuration diagram of a communication device according to an embodiment;

FIG. 2 is a diagram illustrating a first mode of a radio frequency circuit according to the embodiment;

FIG. 3 is a diagram illustrating a second mode of the radio frequency circuit according to the embodiment;

FIG. 4 is a diagram illustrating a third mode of the radio frequency circuit according to the embodiment; and

FIG. 5 is a graph illustrating bandpass characteristics of radio frequency circuits according to the embodiment and a comparative example.

### DETAILED DESCRIPTION

An embodiment of the present disclosure will be described in detail below with reference to the drawings. Note that all embodiments described below provide comprehensive or specific examples. Numerical values, shapes, materials, components, the arrangement and connection configuration of the components, and so forth that are described in the following embodiments are merely examples and are not intended to limit the present disclosure.

Figures are schematic diagrams in which emphasis, omission, or ratio adjustment has been made as appropriate to illustrate the present disclosure. The figures are not necessarily exact illustrations and may illustrate shapes, positional relationships, and ratios different from actual shapes, positional relationships, and ratios. In each figure, components that are substantially the same are denoted by the same reference signs, and a repeated description thereof may be omitted or simplified in some cases.

In the following description, when an element is referred to as being “connected” to another element, the element can not only be directly connected to the other element by using a connection terminal and/or a wiring, but also electrically connected via another circuit element. The expression “C is connected between A and B” refers to a situation in which one end of C is connected to A, the other end of C is connected to B, and C is disposed in series in a path connecting A and B. The “path connecting A and B” refers to a path composed of a conductor electrically connecting A to B.

The term “pass band of a filter” refers to a portion of a frequency spectrum transmitted through the filter and is defined as a frequency band between two frequencies where power insertion loss is 3 dB larger than its minimum value.

The term “transmission band” refers to a frequency band used for transmission in a communication device. The term “reception band” refers to a frequency band used for reception in the communication device. For example, in a frequency division duplex (FDD) band, different frequency bands from each other (uplink band and downlink band) are used as the transmission band and the reception band. Furthermore, for example, in a time division duplex (TDD) band, the same frequency band is used for the transmission band and the reception band.

The term “simultaneous communication-capable band combination” refers to a combination of multiple frequency bands that can be transmitted simultaneously, received simultaneously, or transmitted and received simultaneously. Such a band combination is predefined, for example, by standards bodies (such as the 3rd Generation Partnership Project (3GPP) (registered trademark) and the Institute of Electrical and Electronics Engineers (IEEE)). Examples of “simultaneous communication” include carrier aggregation (CA), E-UTRAN New Radio-Dual Connectivity (EN-DC), New Radio-Dual Connectivity (NR-DC), and New Radio E-UTRAN-Dual Connectivity (NE-DC).

The term “terminal” refers to a point where a conductor within an element terminates. When the impedance of a conductor between elements is sufficiently low, a terminal is interpreted not only as a single point, but also as any point on the conductor between the elements or as the entire conductor.

The expression “a low noise amplifier does not operate” refers to a situation in which the low noise amplifier is controlled to be in an OFF state (that is, a state in which the low noise amplifier is unable to amplify radio frequency signals). Specifically, “the low noise amplifier does not operate” refers to a situation in which, when no bias voltage and/or power supply voltage are/is applied to the low noise amplifier, the low noise amplifier is unable to amplify radio frequency signals. An ON/OFF state of the low noise amplifier can be controlled by applying/not applying a bias voltage and/or a power supply voltage.

Furthermore, terms, such as “parallel” and “perpendicular”, indicating relationships between elements, a term, such as “rectangular”, indicating the shape of an element, and a numerical range do not only refer to their strict meanings but also include a substantially equivalent range, for example, an error of about a few percent.

In the related art described above, however, when attenuation requirements in an out-of-band range away from an in-band range are stringent, the number of components in the radio frequency circuit may increase.

The present disclosure provides a radio frequency circuit that enables an increase in the number of components to be reduced when attenuation requirements in an out-of-band range away from an in-band range are stringent.

### Embodiment

An embodiment will be described below.

### 1. Configuration of Communication Device 5

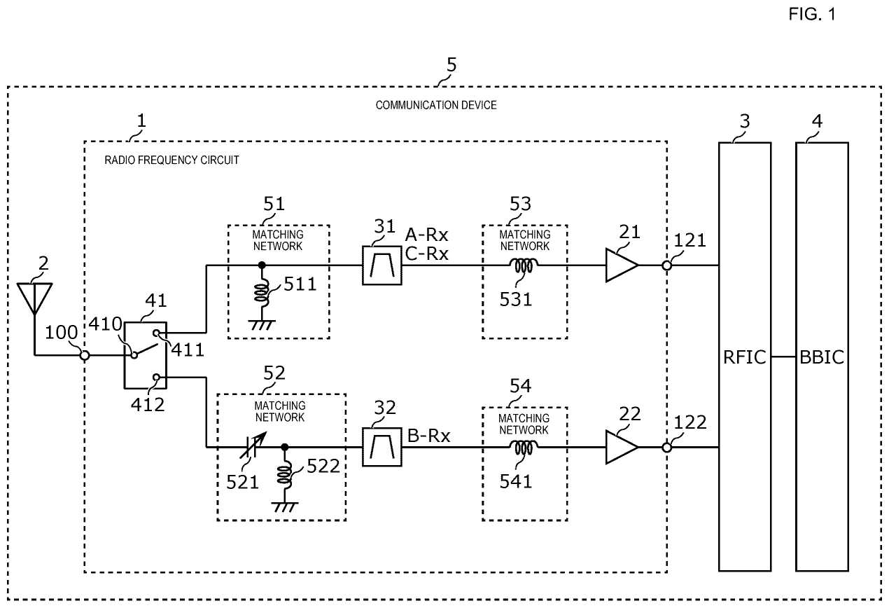

First, a configuration of a communication device 5 according to the present embodiment will be described with reference to FIG. 1. FIG. 1 is a configuration diagram of the communication device 5 according to the present embodiment.

Note that FIG. 1 illustrates an exemplary configuration. The communication device 5 can be implemented by using any of various types of circuit implementation and circuit techniques. Hence, the following description of the communication device 5 is not to be interpreted in a limited manner.

The communication device 5 can be used to provide a wireless connection. For example, the communication device 5 can be implemented in user equipment (UE) in a cellular network (also referred to as a mobile network), such as a mobile phone, a smartphone, a tablet computer, or a wearable device. In another example, the implementation of the communication device 5 enables wireless connections for an Internet of Things (IoT) sensor device, a medical/health care device, a vehicle, an unmanned aerial vehicle (UAV) (so-called drone), and an automated guided vehicle (AGV). In still another example, the implementation of the communication device 5 also enables wireless connections at wireless access points or wireless hotspots.

The communication device 5 includes a radio frequency circuit 1, an antenna 2, a radio frequency integrated circuit (RFIC) 3, and a baseband integrated circuit (BBIC) 4.

The radio frequency circuit 1 can transmit a radio frequency signal between the antenna 2 and the RFIC 3. A circuit configuration of the radio frequency circuit 1 will be described below.

The antenna 2 is connected to the radio frequency circuit 1. The antenna 2 can receive a radio frequency signal from outside the communication device 5 and supply the radio frequency signal to the radio frequency circuit 1. Furthermore, the antenna 2 may receive a radio frequency signal from the radio frequency circuit 1 and transmit the radio frequency signal outside the communication device 5. Note that the antenna 2 does not have to be included in the communication device 5. Moreover, the communication device 5 may further include one or more antennas in addition to the antenna 2.

The RFIC 3 is an example of a signal processing circuit that processes a radio frequency signal. Specifically, the RFIC 3 can perform, for example, through up-conversion, signal processing on a transmission signal input from the BBIC 4 and output a radio frequency transmission signal generated through this signal processing to the radio frequency circuit 1. Furthermore, the RFIC 3 can also perform, for example, through down-conversion, signal processing on a radio frequency reception signal input via the radio frequency circuit 1 and output a reception signal generated through this signal processing to the BBIC 4. Additionally, the RFIC 3 may include a control unit that controls, for example, a switch and an amplifier that are included in the radio frequency circuit 1. Note that some or all functions of the RFIC 3 as a control unit may be included outside the RFIC 3, for example, in the BBIC 4 or the radio frequency circuit 1.

The BBIC 4 is a baseband signal processing circuit that performs signal processing using a lower frequency band than a radio frequency signal transmitted by the radio frequency circuit 1. As signals processed by the BBIC 4, for example, image signals for displaying images and/or voice signals for a phone call through a speaker are used. Note that the BBIC 4 does not have to be included in the communication device 5.

### 2. Circuit Configuration of Radio Frequency Circuit 1

Next, the circuit configuration of the radio frequency circuit 1 according to the present embodiment will be described with reference to FIG. 1. Note that FIG. 1 illustrates an exemplary circuit configuration. The radio frequency circuit 1 can be implemented by using any of various types of circuit implementation and circuit techniques. Hence, the following description of the radio frequency circuit 1 is not to be interpreted in a limited manner.

The radio frequency circuit 1 includes low noise amplifiers 21 and 22, filters 31 and 32, a switch circuit 41, matching networks 51, 52, 53, and 54, an antenna connection terminal 100, and radio frequency output terminals 121 and 122. These components may also be referred to as “circuitry”, e.g., “switch circuitry,” “matching circuity” and includes hardware specifically configured to perform the recited functions. This includes, but is not limited to, discrete electronic components, integrated circuits (ICs), application-specific integrated circuits (ASICs), field-programmable gate arrays (FPGAs), or a combination of hardware and processing circuitry programmed to control the hardware state.

The antenna connection terminal 100 is an external connection terminal of the radio frequency circuit 1. The antenna connection terminal 100 is a terminal for receiving a radio frequency signal from the antenna 2. The antenna connection terminal 100 is connected to the antenna 2 outside the radio frequency circuit 1 and is connected to the switch circuit 41 inside the radio frequency circuit 1.

The radio frequency output terminals 121 and 122 are external connection terminals of the radio frequency circuit 1 and are terminals for supplying radio frequency signals to the RFIC 3. The radio frequency output terminals 121 and 122 are connected to the RFIC 3 outside the radio frequency circuit 1 and are connected to the respective low noise amplifiers 21 and 22 inside the radio frequency circuit 1.

The low noise amplifier 21 is connected between the filter 31 and the radio frequency output terminal 121. Specifically, an input end of the low noise amplifier 21 is connected to the filter 31 via the matching network 53, and an output end of the low noise amplifier 21 is connected to the radio frequency output terminal 121. The low noise amplifier 21 can be switched between ON and OFF states in accordance with a digital control signal from the RFIC 3, for example.

The low noise amplifier 22 is connected between the filter 32 and the radio frequency output terminal 122. Specifically, an input end of the low noise amplifier 22 is connected to the filter 32 via the matching network 54, and an output end of the low noise amplifier 22 is connected to the radio frequency output terminal 122. The low noise amplifier 22 can be switched between ON and OFF states in accordance with a digital control signal from the RFIC 3, for example.

Note that the low noise amplifier 21 and/or the low noise amplifier 22 do/does not have to be included in the radio frequency circuit 1. In this case, the low noise amplifier 21 and/or the low noise amplifier 22 may be connected between the radio frequency circuit 1 and the RFIC 3 or may be included in the RFIC 3.

The filter 31 is an example of a first filter and is a band pass filter having a pass band including a reception band of a band A (A-Rx) and a reception band of a band C (C-Rx). Note that the filter 31 is not limited to the band pass filter. The filter 31 may be a band elimination filter, a high pass filter, a low pass filter, or any combination of these filters. Furthermore, the pass band of the filter 31 does not have to include the reception band of the band C.

The filter 31 is connected between the switch circuit 41 and the low noise amplifier 21. Specifically, one end of the filter 31 is connected to the switch circuit 41 via the matching network 51. The other end of the filter 31 is connected to the input end of the low noise amplifier 21 via the matching network 53.

The filter 32 is an example of a second filter and is a band pass filter having a pass band including a reception band of a band B (B-Rx). Note that the filter 32 is not limited to the band pass filter. The filter 32 may be a band elimination filter, a high pass filter, a low pass filter, or any combination of these filters.

The filter 32 is connected between the switch circuit 41 and the low noise amplifier 22. Specifically, one end of the filter 32 is connected to the switch circuit 41 via the matching network 52. The other end of the filter 32 is connected to the input end of the low noise amplifier 22 via the matching network 54.

As the filters 31 and 32, surface acoustic wave (SAW) filters, bulk acoustic wave (BAW) filters, LC or dielectric filters, or any combination of these filters may be used. Furthermore, the filters 31 and 32 are not limited to these.

The bands A to C are frequency bands for a communication system built using radio access technology (RAT). The bands A to C are predefined, for example, by standard bodies (such as 3GPP and IEEE). Examples of a communication system can include a 5th Generation New Radio (5GNR) system, a 4th Generation Long Term Evolution (4GLTE) system, and a 2nd Generation Global System for Mobile Communications (2GGSM).

The band A is an example of a first band and is any of an FDD band, a TDD band, and a supplementary downlink (SDL) band. As the band A, for example, Band 53 for LTE, or n53 or n254 for 5GNR can be used. Note that the reception band of the band A may completely include the reception band of the band C or partially include the reception band of the band C.

The band B is an example of a second band and is any of an FDD band, a TDD band, and an SDL band. As the band B, for example, Band 1, Band 3, Band 25, Band 34, Band 39, Band 40, or Band 66 for LTE, or n1, n3, n25, n34, n39, n40, or n66 for 5GNR can be used.

The band C is an example of a third band and is any of an FDD band, a TDD band, and an SDL band. The reception band of the band C is closer to the reception band of the band A than the reception band of the band B. That is, a difference between center frequencies of the bands A and C is smaller than a difference between center frequencies of the bands B and C. Furthermore, reception of a signal in the band C can be performed simultaneously with reception of a signal in the band B. That is, the bands B and C are a simultaneous communication-capable band combination. As the band C, for example, Band 41 for LTE, or n41 for 5GNR can be used. Note that the reception band of the band C may completely include the reception band of the band A or partially include the reception band of the band A.

The switch circuit 41 is connected between the antenna connection terminal 100 and the filters 31 and 32. Specifically, the switch circuit 41 includes a common terminal 410, and selection terminals 411 and 412. The common terminal 410 is connected to the antenna connection terminal 100. The selection terminal 411 is an example of a first selection terminal and is connected to the filter 31 via the matching network 51. The selection terminal 412 is an example of a second selection terminal and is connected to the filter 32 via the matching network 52.

In such a configuration, the switch circuit 41 can connect the common terminal 410 to the selection terminals 411 and 412 in accordance with a digital control signal from the RFIC 3, for example. Specifically, the switch circuit 41 is a multi-connection switch circuit and can independently control the connection between the common terminal 410 and the selection terminal 411 and the connection between the common terminal 410 and the selection terminal 412.

The matching network 51 is an example of a first matching network and is connected between the selection terminal 411 of the switch circuit 41 and the filter 31. Specifically, one end of the matching network 51 is connected to the selection terminal 411 of the switch circuit 41. The other end of the matching network 51 is connected to the one end of the filter 31. The matching network 51 includes an inductor 511 connected between a path connecting the selection terminal 411 and the filter 31 and a ground. Such a circuit configuration enables the matching network 51 to provide impedance matching between the switch circuit 41 and the filter 31. In particular, the inductor 511 serves as a shunt inductor configured to provide an inductive reactance that compensates for a capacitive component of the first filter 31 or the switch circuit 41, thereby achieving a substantially matched impedance (e.g., 50 ohms) at the antenna connection terminal 100 for the first band. Note that the circuit configuration of the matching network 51 is not limited to the circuit configuration illustrated in FIG. 1.

The matching network 52 is an example of a second matching network and is connected between the selection terminal 412 of the switch circuit 41 and the filter 32. Specifically, one end of the matching network 52 is connected to the selection terminal 412 of the switch circuit 41. The other end of the matching network 52 is connected to the one end of the filter 32. The matching network 52 includes a capacitor 521 and an inductor 522.

The capacitor 521 is a tunable capacitor and is connected between the selection terminal 412 and the filter 32. For example, the capacitor 521 has an electrostatic capacity of 1 to 10 pF. Note that the capacitor 521 does not have to be a tunable capacitor and may be a capacitor having a fixed electrostatic capacity. By varying the capacitance, the radio frequency circuit 1 can dynamically shift the frequency of an attenuation pole to target different interference sources depending on which band is selected as the first band (e.g., Band 53 vs. n254).

The inductor 522 is connected between a path connecting the capacitor 521 and the filter 32 and the ground. For example, the inductor 522 has an inductance of 1 to 10 nH. Such a circuit configuration enables the matching network 52 to provide impedance matching between the switch circuit 41 and the filter 32.

Note that the circuit configuration of the matching network 52 is not limited to the circuit configuration illustrated in FIG. 1. For example, the matching network 52 may include an inductor connected between the selection terminal 412 and the filter 32, and a capacitor connected between a path connecting this inductor and the filter 32 and the ground. That is, the positions of the capacitor 521 and the inductor 522 may be switched. Furthermore, for example, the capacitor 521 may be connected between the inductor 522 and the ground.

The matching network 53 is connected between the filter 31 and the low noise amplifier 21. Specifically, one end of the matching network 53 is connected to the other end of the filter 31. The other end of the matching network 53 is connected to the input end of the low noise amplifier 21. The matching network 53 includes an inductor 531 connected between the filter 31 and the low noise amplifier 21. Such a circuit configuration enables the matching network 53 to provide impedance matching between the filter 31 and the low noise amplifier 21. Note that the circuit configuration of the matching network 53 is not limited to the circuit configuration illustrated in FIG. 1.

The matching network 54 is connected between the filter 32 and the low noise amplifier 22. Specifically, one end of the matching network 54 is connected to the other end of the filter 32. The other end of the matching network 54 is connected to the input end of the low noise amplifier 22. The matching network 54 includes an inductor 541 connected between the filter 32 and the low noise amplifier 22. Such a circuit configuration enables the matching network 54 to provide impedance matching between the filter 32 and the low noise amplifier 22. Note that the circuit configuration of the matching network 54 is not limited to the circuit configuration illustrated in FIG. 1.

### 3. Communication Mode

Next, a communication mode of the radio frequency circuit 1 according to the present embodiment will be described.

### 3.1. First Mode

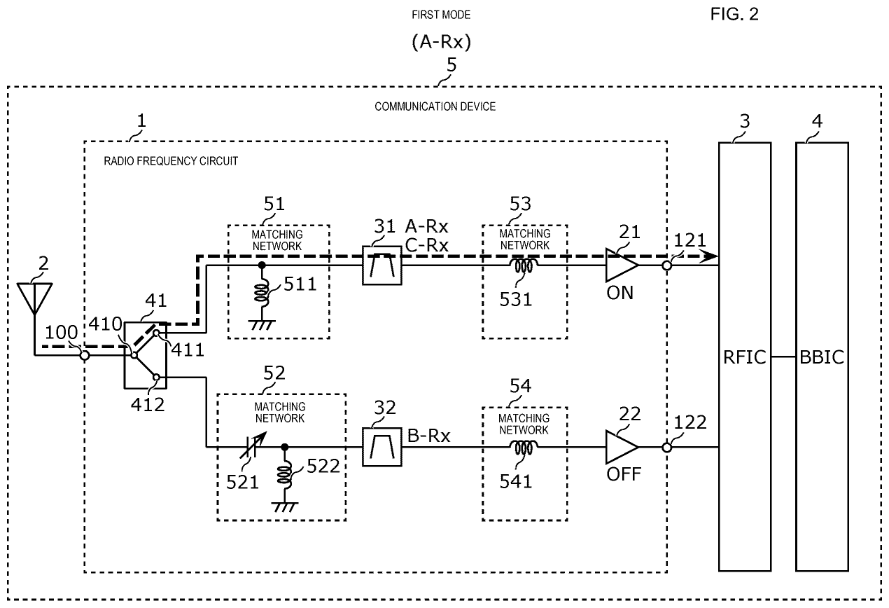

First, a first mode included in the communication mode of the radio frequency circuit 1 will be described with reference to FIG. 2. FIG. 2 is a diagram illustrating the first mode of the radio frequency circuit 1 according to the present embodiment. In FIG. 2, a dashed arrow indicates a transmission path of reception signals in the band A.

The first mode is a communication mode in which a signal in the band A is received and no signals in the bands B and C are received. In the first mode, the switch circuit 41 connects the common terminal 410 to the selection terminals 411 and 412. Furthermore, the low noise amplifier 21 operates, and the low noise amplifier 22 does not operate.

In such a state, a reception signal in the band A is transmitted from the antenna 2 to the RFIC 3 via the antenna connection terminal 100, the switch circuit 41, the matching network 51, the filter 31, the matching network 53, the low noise amplifier 21, and the radio frequency output terminal 121.

Note that, in the first mode, in the switch circuit 41, the common terminal 410 is connected not only to the selection terminal 411 but also to the selection terminal 412. This connects an LC series circuit composed of the capacitor 521 and the inductor 522 between the transmission path of reception signals in the band A and the ground. Thus, when a resonant frequency of the capacitor 521 and the inductor 522 is appropriately set, the matching network 52 can increase attenuation in a frequency band (out-of-band range) away from the reception band (in-band range) of the band A. Specifically, when the resonant frequency of the capacitor 521 and the inductor 522 is set near a frequency band in which attenuation requirements are stringent, the radio frequency circuit 1 can provide necessary attenuation in this frequency band. This specific LC combination is configured to resonate at a frequency distinct from the pass band of the first filter 31, thereby functioning as a trap for undesired out-of-band signals. By configuring a resonant frequency of the capacitor 521 and the inductor 522 to correspond to an out-of-band frequency range of the band A, the matching network 52 forms an attenuation pole (or notch circuit) that increases attenuation in the out-of-band range. Specifically, when the resonant frequency is configured to be within a predetermined frequency range relative to a specified attenuation requirement, the radio frequency circuit 1 provides the necessary attenuation without requiring an additional dedicated filter component.

### 3.2. Second Mode

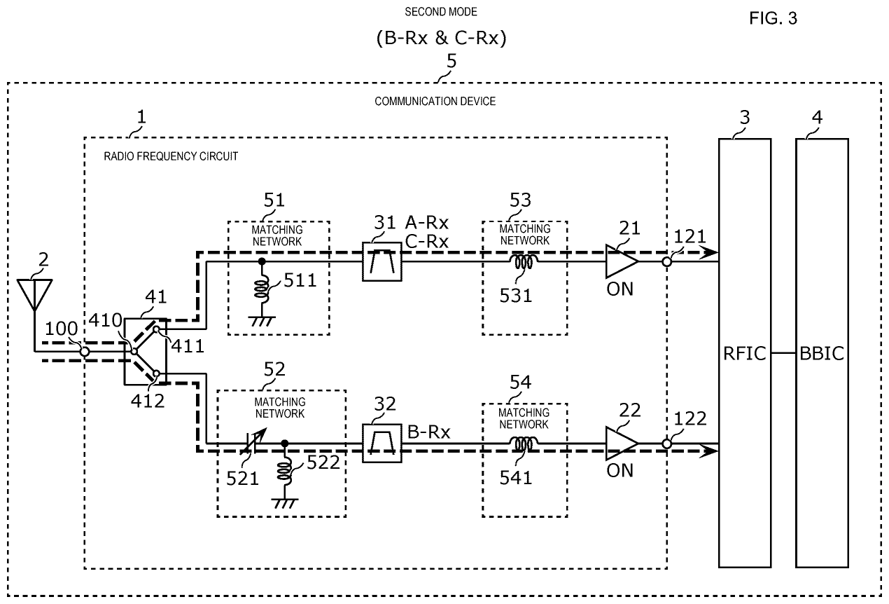

Next, a second mode included in the communication mode of the radio frequency circuit 1 will be described with reference to FIG. 3. FIG. 3 is a diagram illustrating the second mode of the radio frequency circuit 1 according to the present embodiment. In FIG. 3, dashed arrows indicate transmission paths of reception signals in the bands B and C.

The second mode is a communication mode in which signals in the bands B and C are received simultaneously and no signal in the band A is received. In the second mode, the switch circuit 41 connects the common terminal 410 to the selection terminals 411 and 412. Furthermore, the low noise amplifiers 21 and 22 operate.

In such a state, a reception signal in the band B is transmitted from the antenna 2 to the RFIC 3 via the antenna connection terminal 100, the switch circuit 41, the matching network 52, the filter 32, the matching network 54, the low noise amplifier 22, and the radio frequency output terminal 122. Furthermore, a reception signal in the band C is transmitted from the antenna 2 to the RFIC 3 via the antenna connection terminal 100, the switch circuit 41, the matching network 51, the filter 31, the matching network 53, the low noise amplifier 21, and the radio frequency output terminal 121.

Note that, in the second mode, the matching network 52 can provide impedance matching between the switch circuit 41 and the filter 32 in the reception band of the band B.

### 3.3. Third Mode

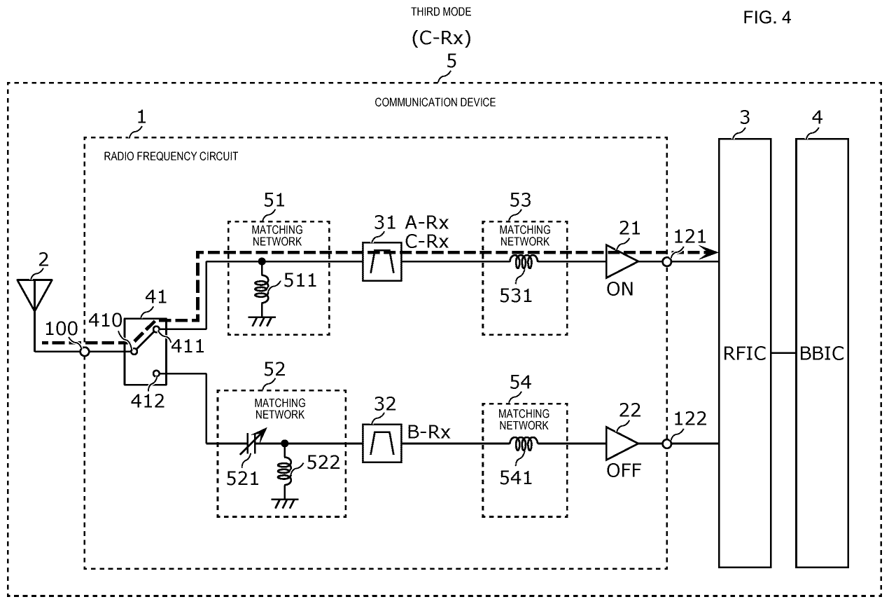

Next, a third mode included in the communication mode of the radio frequency circuit 1 will be described with reference to FIG. 4. FIG. 4 is a diagram illustrating the third mode of the radio frequency circuit 1 according to the present embodiment. In FIG. 4, a dashed arrow indicates a transmission path of reception signals in the band C.

The third mode is a communication mode in which a signal in the band C is received and no signals in the bands A and B are received. In the third mode, the switch circuit 41 connects the common terminal 410 to the selection terminal 411 and does not connect the common terminal 410 to the selection terminal 412. Furthermore, the low noise amplifier 21 operates, and the low noise amplifier 22 does not operate.

In such a state, a reception signal in the band C is transmitted from the antenna 2 to the RFIC 3 via the antenna connection terminal 100, the switch circuit 41, the matching network 51, the filter 31, the matching network 53, the low noise amplifier 21, and the radio frequency output terminal 121.

Note that the communication mode of the radio frequency circuit 1 is not limited to the first mode, the second mode, and the third mode. For example, the communication mode of the radio frequency circuit 1 may include a mode in which a signal in the band B is received independently.

### 4. Bandpass Characteristics of Radio Frequency Circuit 1

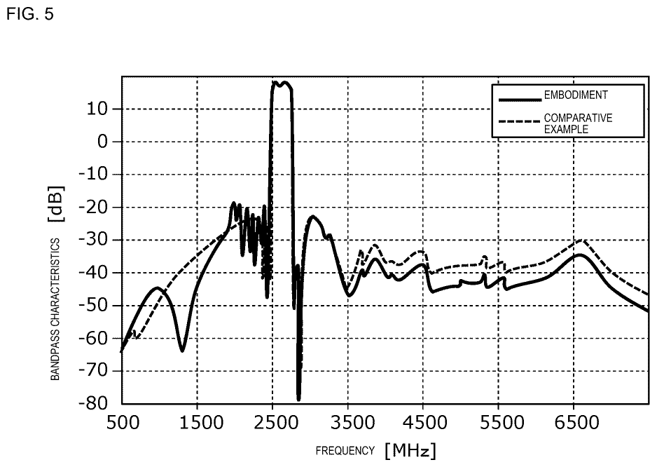

Next, bandpass characteristics of the radio frequency circuit 1 will be described with reference to FIG. 5. FIG. 5 is a graph illustrating bandpass characteristics of radio frequency circuits according to the present embodiment and a comparative example.

A circuit configuration of the radio frequency circuit according to the comparative example is similar to that of the radio frequency circuit 1 according to the present embodiment. However, the comparative example differs from the present embodiment in that, in the first mode, the common terminal 410 is not connected to the selection terminal 412.

In the present embodiment, the common terminal 410 is connected to the selection terminal 412, and the LC series circuit composed of the capacitor 521 and the inductor 522 is thus connected between the transmission path of reception signals in the band A and the ground. As a result, as illustrated in FIG. 5, an attenuation pole is formed near 1300 MHz, and attenuation can thus be increased in a frequency band (out-of-band range) (1610 to 1626.5 MHz) away from the reception band (in-band range) (2483.5 to 2495 MHz or 2483.5 to 2500 MHz) of the band A. Furthermore, in the radio frequency circuit 1, the electrostatic capacity of the capacitor 521 can also be adjusted to bring the attenuation pole closer to a frequency band in which attenuation requirements are stringent and to further increase the attenuation in this out-of-band range.

### 5. Summary

As described above, the radio frequency circuit 1 according to the present embodiment includes: the filter 31 having the pass band including the reception band of the band A; the filter 32 having the pass band including the reception band of the band B; the switch circuit 41 including the common terminal 410 connected to the antenna connection terminal 100, the selection terminal 411 connected to the filter 31, and the selection terminal 412 connected to the filter 32; the matching network 51 connected between the selection terminal 411 and the filter 31; and the matching network 52 connected between the selection terminal 412 and the filter 32. In the first mode in which a signal in the band A is received and no signal in the band B is received, the switch circuit 41 is configured to connect the common terminal 410 to the selection terminal 411 and the selection terminal 412.

Thus, in the first mode in which a signal in the band A is received and no signal in the band B is received, the switch circuit 41 is configured to connect the common terminal 410 to the selection terminal 412, thereby connecting the matching network 52 to the transmission path of reception signals in the band A. This connection electrically couples the matching network 52 to the transmission path of the first band signals. Accordingly, the matching network 52 is configured to increase attenuation in an out-of-band frequency range of the first band. By utilizing the matching network 52 as an attenuation circuit, stringent attenuation requirements in a frequency band (out-of-band range) away from the reception band (in-band range) of the band A, can be satisfied without requiring a longitudinally coupled SAW resonator to enhance the attenuation characteristics of the first filter 31. Furthermore, the radio frequency circuit 1 can achieve target attenuation while minimizing component count, e.g., additional inductors and/or capacitors do not need to be added to the filter 31 or the matching network 51.

Additionally, for example, in the radio frequency circuit 1 according to the present embodiment, the matching network 52 may include the capacitor 521 connected between the selection terminal 412 and the filter 32, and the inductor 522 connected between the path connecting the capacitor 521 and the filter 32 and the ground.

Thus, when the common terminal 410 is connected to the selection terminals 411 and 412, the capacitor 521 and the inductor 522 are connected in series between the transmission path of reception signals in the band A and the ground. Hence, the matching network 52 can function as a notch circuit to increase attenuation in a frequency band (out-of-band range) away from the reception band (in-band range) of the band A.

Additionally, for example, in the radio frequency circuit 1 according to the present embodiment, the capacitor 521 may be a tunable capacitor.

This enables the electrostatic capacity of the capacitor 521 to be adjusted to an electrostatic capacity suitable for an impedance matching network for the band B and an electrostatic capacity suitable for a notch circuit for the band A, thus improving characteristics of the radio frequency circuit 1.

Additionally, for example, in the radio frequency circuit 1 according to the present embodiment, the pass band of the filter 31 may further include the reception band of the band C, and the bands B and C may be a simultaneous communication-capable band combination.

This enables the filter 31 to be shared by two bands, reducing the number of filters. Furthermore, since the bands B and C are a simultaneous communication-capable band combination, there is a high necessity to connect the filter 31 for the bands A and C and the filter 32 for the band B to the same switch circuit 41. That is, the matching network 52 for the band B easily serves as a notch circuit for the band A.

Additionally, for example, in the radio frequency circuit 1 according to the present embodiment, in the second mode in which signals in the bands B and C are received simultaneously and no signal in the band A is received, the switch circuit 41 may be configured to connect the common terminal 410 to the selection terminal 411 and the selection terminal 412. In the third mode in which a signal in the band C is received and no signals in the band A and the band B are received, the switch circuit 41 may be configured to connect the common terminal 410 to the selection terminal 411 and not to connect the common terminal 410 to the selection terminal 412.

This enables simultaneous reception of signals in the bands B and C in the second mode and also enables independent reception of a signal in the band C in the third mode.

Additionally, for example, the radio frequency circuit 1 according to the present embodiment may further include the low noise amplifier 22 connected to the filter 32. The low noise amplifier 22 may be configured not to operate in the first mode.

Thus, when the matching network 52 is configured as a notch circuit for the band A, impedance in the reception band of the band A as seen from the common terminal 410 looking toward the filter 32 and the low noise amplifier 22 is increased closer to a substantially open state, thereby keeping a reception signal in the band A from leaking into the low noise amplifier 22. This high-impedance state effectively prevents the radio frequency signal of the first band from leaking into the low noise amplifier 22, thereby minimizing insertion loss for the first band and maintaining signal integrity.

Additionally, for example, in the radio frequency circuit 1 according to the present embodiment, the band A may be Band 53 for LTE, or n53 or n254 for 5GNR. The band B may be Band 1, Band 3, Band 25, Band 34, Band 39, Band 40, or Band 66 for LTE, or n1, n3, n25, n34, n39, n40, or n66 for 5GNR. The band C may be Band 41 for LTE, or n41 for 5GNR.

This enables the radio frequency circuit 1 to be used in an LTE system or a 5GNR system. In particular, in Band 53 for LTE, or n53 or n254 for 5GNR, attenuation requirements are stringent in a frequency band (1610 to 1626.5 MHz) away from the reception band (2483.5 to 2495 MHz or 2483.5 to 2500 MHz), and thus the effect of using the matching network 52 as a notch circuit is great.

### Other Embodiments

Although a radio frequency circuit according to the present disclosure has been described above with an embodiment, the radio frequency circuit according to the present disclosure is not limited to the above-described embodiment. The present disclosure also encompasses another embodiment achieved by combining any components in the above-described embodiment, modifications obtained by making various modifications conceived by a person skilled in the art to the above-described embodiment within the scope of the gist of the present disclosure, and various devices including the above-described radio frequency circuit.

For example, in the circuit configuration of the radio frequency circuit according to the above-described embodiment, another circuit element, a line, and so forth may be inserted between paths connecting circuit elements and signal paths that are illustrated in the drawings. For example, a coupler may be connected between the switch circuit 41 and the antenna connection terminal 100.

The present disclosure can be widely used in communication equipment, such as a mobile phone, as a radio frequency circuit disposed in a front-end section.

What is claimed is:

1. A radio frequency circuit comprising:
a first filter having a pass band including a reception band of a first band;
a second filter having a pass band including a reception band of a second band;
a switch circuit including a common terminal connected to an antenna connection terminal, a first selection terminal connected to the first filter, and a second selection terminal connected to the second filter;
a first matching network connected between the first selection terminal and the first filter; and
a second matching network connected between the second selection terminal and the second filter,
wherein, in a first mode in which a signal in the first band is received and no signal in the second band is received, the switch circuit is configured to connect the common terminal to both the first selection terminal and the second selection terminal.

2. The radio frequency circuit according to claim 1,
wherein the second matching network includes
a capacitor connected between the second selection terminal and the second filter, and
an inductor connected between a path connecting the capacitor and the second filter and a ground.

3. The radio frequency circuit according to claim 2,
wherein the capacitor is a tunable capacitor.

4. The radio frequency circuit according to claim 3, wherein an electrostatic capacity of the tunable capacitor is adjusted in the first mode to set a resonant frequency of the second matching network circuitry to an attenuation frequency of the first band.

5. The radio frequency circuit according to claim 2,
wherein the inductor and the capacitor of the second matching network form an LC series circuit connected between a transmission path of the signal in the first band and the ground in the first mode.

6. The radio frequency circuit according to claim 1,
wherein the pass band of the first filter further includes a reception band of a third band, and
wherein the second band and the third band are a simultaneous communication-capable band combination.

7. The radio frequency circuit according to claim 6,
wherein, in a second mode in which signals in the second band and the third band are received simultaneously and no signal in the first band is received, the switch circuit is configured to connect the common terminal to the first selection terminal and the second selection terminal.

8. The radio frequency circuit according to claim 7,
wherein, in a third mode in which a signal in the third band is received and no signals in the first band and the second band are received, the switch circuit is configured to connect the common terminal to the first selection terminal and not to connect the common terminal to the second selection terminal.

9. The radio frequency circuit according to claim 1,
further comprising a low noise amplifier connected to the second filter, the low noise amplifier being configured not to operate in the first mode.

10. The radio frequency circuit according to claim 9, wherein the low noise amplifier is controlled to be in an OFF state in the first mode such that an impedance as seen from the common terminal toward the second filter is substantially an open circuit.

11. The radio frequency circuit according to claim 1,
wherein the first band is Band 53 for Long Term Evolution (LTE), or n53 or n254 for 5th Generation New Radio (5GNR).

12. The radio frequency circuit according to claim 6,
wherein the first band is Band 53 for Long Term Evolution (LTE), or n53 or n254 for 5th Generation New Radio (5GNR),
wherein the second band is Band 1, Band 3, Band 25, Band 34, Band 39, Band 40, or Band 66 for LTE, or n1, n3, n25, n34, n39, n40, or n66 for 5GNR, and
wherein the third band is Band 41 for LTE, or n41 for 5GNR.

13. The radio frequency circuit according to claim 1, wherein the first matching network includes a shunt inductor connected between a path connecting the first selection terminal and the first filter and a ground.

14. A communication device comprising:
an antenna connection terminal;
the radio frequency circuit of claim 1; and
a radio frequency integrated circuit (RFIC) configured to provide a control signal to the switch circuitry to select between the first mode and a second mode.

15. A radio frequency circuit comprising:
a first reception path for a first frequency band including a first filter and first matching circuitry;
a second reception path for a second frequency band including a second filter and second matching circuitry; and
switch circuitry configured to, during reception of the first frequency band, connect an antenna terminal to both the first reception path and the second reception path such that the second matching circuitry operates as an attenuation circuit for the first frequency band.

16. The radio frequency circuit of claim 15, wherein the second matching circuitry includes a tunable capacitor and an inductor.

17. The radio frequency circuit of claim 15, wherein the second matching circuitry provides impedance matching for the second frequency band when the second reception path is active.

18. A method for controlling a radio frequency circuit, the method comprising:
operating the radio frequency circuit in a first mode to receive a first frequency band via a first filter path;
controlling a switch circuit to connect a common terminal to both a first selection terminal associated with the first filter path and a second selection terminal associated with a second filter path; and
utilizing a matching network of the second filter path to increase attenuation in an out-of-band range of the first frequency band while the first frequency band is being received.
